(19) United States
(12) Patent Application Publication
(10) Pub. No.: US 2026/0119840 A1
(43) Pub. Date: Apr. 30, 2026

(54) Method for reconstructing the distribution of the electrical properties of materials using electrical impedance tomography

(71) Applicants: COMMISSARIAT A L'ENERGIE ATOMIQUE ET AUX ENERGIES ALTERNATIVES, Paris (FR); CENTRE NATIONAL DE LA RECHERCHE SCIENTIFIQUE, Paris (FR); UNIVERSITE D'AIX MARSEILLE, MARSEILLE (FR); CENTRALE MEDITERRANEE, Marseille (FR)

(72) Inventor: Anes SAOUDI, Saint-Paul lez Durance (FR)

(21) Appl. No.: 19/198,333

(22) Filed: May 5, 2025

(30) Foreign Application Priority Data
May 6, 2024 (FR) 2404751

(51) Int. Cl. G06N 3/0455; G01N 27/02; G06N 3/0464

(52) U.S. Cl. CPC G06N 3/0455; G01N 27/026; G06N 3/0464

(57) ABSTRACT

A method for reconstructing the distribution of the electrical properties of at least one material of a body including a cylindrical part containing a fluid, using a neural network and data on electrical values of the body measured beforehand by electrical impedance tomography using electrodes arranged around a periphery of the cylindrical part of the body, each electrode having been excited by a potential of predefined form. The neural network including an autoencoder having a plurality of levels (L₁, . . . , L_{J}) each comprising at least one convolution layer and at least one dropout layer, and an attention module comprising attention gates (AG₁, . . . , AG_{J-1}), each having an associated attention signal (gⱼ).

### TECHNICAL FIELD

The present invention relates to the field of electrical impedance tomography.

More particularly, the invention relates to a method for reconstructing the distribution of the electrical properties of materials of a body comprising a cylindrical part containing a fluid, using a neural network and data on electrical properties of the body that were measured beforehand by electrical impedance tomography.

The invention also relates to a computer program product configured to implement this method.

The main application of the present invention is monitoring fluid flows that are liable to vary abruptly, as may be the case with fluids flowing under high pressure and at high temperature.

One application of particular interest is monitoring pipes in nuclear facilities, but other applications may be envisaged within the scope of the invention.

### BACKGROUND

Electrical impedance tomography (EIT) is a non-invasive, non-destructive technique that allows the interior of an object to be viewed in real time and continuously, by measuring the electrical properties (potential and electrical current) of the object at its surface. This approach, which is robust, is particularly suitable for taking non-intrusive measurements in high-pressure and/or high-temperature environments.

Compared to MRI and CT, EIT has a fast frame rate of as high as several kHz, and a lower spatial resolution due to the non-linearity of the inverse problem.

More precisely, EIT consists in injecting electrical currents or potentials by means of a set of non-intrusive electrodes placed on the surface of the monitored object and then measuring the electrical potentials or currents on the surface of the object.

The electrodes may only make contact with the outer surface of the object. However, if the surface of the object is made of metal, the electrodes must pass through the wall and make contact with the fluid.

The excitation model applied through the electrode pairs, along with the voltage measurements, results in a mapping between current and voltage. The impedance map inside the object is reconstructed by solving the associated inverse problem, in order to find the internal distribution of conductivity and permittivity, in accordance with Ohm's law.

Initially, the algorithms used to solve the nonlinear inverse problem of EIT were mainly iterative mathematical theories, such as Tikhonov regularization (TR), linear back projection (LBP), the Gauss-Newton method (GNM), and Newton's one-step error reconstruction (NOSER). These methods use the first-order linear approximation to conjugate the nonlinear mapping, this leading to low resolution and to a high sensitivity to noise during the measurements, not to mention computing time increasing exponentially with the amount of data.

Over the past thirty years, methods using artificial neural networks have enabled major advances in the field of EIT, due to their ability to map complex nonlinear relationships with a good convergence and low levels of error. This results in higher spatial resolution and a shorter runtime, not only when solving the inverse problem, but also when denoising, achieving super-resolution and segmenting images.

Patent application FR 3 121 234 describes an image-reconstructing method using the NOSER algorithm and implementing frequency multiplexing in which the excitation signals are applied simultaneously to all the electrodes. In order to discriminate between the signals, each electrode is excited by a signal of trigonometric form. Exciting all the electrodes simultaneously avoids the redundancy found in data obtained when the paired electrodes are excited sequentially. However, the obtained spatial resolution is sometimes insufficient to detect certain objects.

Article [1] describes the ADALINE network, based on an adaptive linear element. The work described in article [2] applied backpropagation networks, and the work described in article [3] studied Bayesian multilayer perceptrons. These studies were carried out on reconstruction operators of linear formation, measuring the difference between voltage measurements and thereby avoiding non-linearity between voltage and conductivity.

To overcome the non-linearity of EIT, the method of article [4] uses the radial-basis-function neural network, and the method of article [5] explored a dense neural network with simulated EIDORS data. Recent studies focus more on complex architectures, as described in article [6], in which a finely tuned autoencoder method is applied to EIT lung monitoring, or in article [7], which proposes a multilayer autoencoder. The researchers of article [8] investigated use of energy-based priors with a physics-informed neural network to improve model learning, while those of article [9] used hybrid-fusion learning for high-resolution reconstruction.

Patent application WO 2022/77866 describes an electrical impedance imaging method using an original voltage data set measured on an area to be tested. An initial conductivity distribution sequence of the area forms a corresponding training data set, to which noise is added. A variational autoencoder is trained with these training data. Depending on the input voltage data set, an encoder of the variational autoencoder is trained to obtain an input voltage data feature, and a mapping relationship is established between the input voltage data set and a corresponding conductivity distribution sequence using a decoder of the trained variational autoencoder.

With the continuous progress of deep learning in EIT, better results than obtained with conventional algorithms have begun to be obtained.

Conventionally, the inverse problem is solved without taking into account the advantageousness of giving the artificial intelligence (AI) indications as to points to be privileged to improve the spatial resolution of the result.

However, improving image reconstruction is essential. Identification of the best correspondence between the injected current or potential and the conductivity distribution may lead to a low spatial resolution because of the poorly posed nature of the problem.

There is therefore a need to provide a method for processing EIT measurements that overcomes the drawbacks of the prior art, in particular to improve the image spatial resolution.

The aim of the invention is to at least partially meet this need.

### SUMMARY OF THE INVENTION

To this end, the invention relates, according to one of its aspects, to a method for reconstructing the distribution of the electrical properties of a body comprising a cylindrical part within which a fluid flows, using a neural network and data on electrical values of the body measured beforehand by electrical impedance tomography using electrodes arranged around a periphery of the cylindrical part of the body, each electrode having been excited by a potential of predefined form,
the neural network comprising:
   an autoencoder comprising a plurality of levels L₁, . . . , L_{J} each comprising at least one convolution layer and at least one dropout layer, and
   an attention module comprising attention gates AG₁, . . . , AG_{J-1}, each having an associated attention signal gⱼ,
the method comprising the following steps:
i) the data on electrical values are processed successively by each level L₁, . . . , L_{J} of convolution layers and of dropout layers of the autoencoder of the neural network so as to encode the data to obtain encoded data x₁, . . . , x_{J} for each layer level L₁, . . . , L_{J},
ii) in order to compute the coefficient αⱼ of an attention gate AGⱼ, the latter is configured to add the encoded data x₁, . . . , x_{J} to the attention signal gⱼ of the corresponding attention gate AGⱼ, depending at least on the concatenation of the output data \hat{x}ⱼ₊₁ of the attention gate of higher rank AGⱼ₊₁ and on decoded data originating from the level of higher rank Lⱼ₊₂ than that of the attention gate of higher rank AGⱼ₊₁, the result of this addition being transformed by at least one mathematical function so as to obtain the coefficient αⱼ,
iii) the output data \hat{x}ⱼ of a layer level Lⱼ of the autoencoder are multiplied by the coefficient αⱼ of the corresponding attention gate AGⱼ to obtain output data \hat{x}ⱼ of the j-th attention gate AGⱼ,
iv) the previous step is repeated until a first attention gate AG₁ is reached, in order to obtain the output data \hat{x}₁ of the first attention gate AG₁,
v) said output data \hat{x}₁ of the first attention gate AG₁ are concatenated with the decoded data delivered by the second level L₂ in order to obtain a data matrix representative of an image of the distribution of the electrical properties of at least one material of the body.

By virtue of the invention, it is possible to reconstruct the distribution of electrical properties of materials, in particular their conductivity and permittivity, with a better spatial resolution.

The method according to the invention uses an end-to-end neural network, which could be called an Autoencoder Improved Attention-Net (AIA-Net). The first segment is an autoencoder used as an architecture for extracting remodelling features for the voltage input, and the second segment is an improved attention module allowing the inverse problem to be solved and delivering the image of the distribution of the electrical properties of the materials under test.

Since the excitation potential of the electrodes is of known predefined form, it is possible to reconstruct electrical conductivity and/or electrical permittivity. By virtue of the attention gates of the invention, which have knowledge of the correspondence between the measured electrical values and the electrical properties of the materials, the spatial resolution of the output image is very satisfactory.

### Autoencoder

The dropout layers are used, in a known way, to activate or not activate the neurons. This technique reduces overfitting during training of the model. Some neurons and all the corresponding incoming and outgoing connections may be temporarily deactivated in the network. The choice of neurons to be deactivated is advantageously random.

In one preferred embodiment, max-pooling from one layer level L₁, . . . , L_{J} to another is used to compress the data on electrical values. This process is called max pooling. The max-pooling process is carried out by passing a window, or filter, of predetermined size over the entire input. The window moves over the image and selects the maximum of each portion of the image (called the pooling window or region). The window slides over the input and, for each window position, the highest value is selected and placed in the output matrix.

Skip connections are advantageously formed between the layer levels L₁, . . . , L_{J} to deliver the encoded data x₁, . . . , x_{J} to the input of the attention gates. In a known manner, this technique allows convolutional neural networks to bypass certain layers and to connect directly to deeper or shallower layers.

Preferably, in step ii), the encoded data (x₁, . . . , x_{J}) are, depending on their spatial dimension, convoluted or transposed to match the spatial dimension of the attention signal in question.

### Attention Module

The attention gates of the attention module in the decoding part are advantageously used as filters for the information crossed between the coding part, by transporting features through the skip connections, and the decoding part. This crossed-information may be enhanced by adding to the upper layers the features extracted from each layer in the decoding part.

Known EIT methods using artificial intelligence focus on the nonlinear correspondence between voltage and conductivity, without giving the neural network any indication of where to look.

The attention mechanism was introduced in article [10], in which it was formulated as follows for so-called soft attention:

$$[ Math 1 ]$$

$${q}_{att}^{l} = {ψ}^{T} ( {σ}_{1} ( {W}_{x}^{T} {x}_{i}^{l} + {W}_{g}^{T} {g}_{i} + {b}_{g} ) ) + {b}_{ψ}$$

$$[ Math 2 ]$$

$${α}_{i}^{l} = {σ}_{2} ( {q}_{att}^{l} ( {x}_{i}^{l} , {g}_{i} ; {Θ}_{a t t} ) )$$

Preferably, the coefficient αⱼ of the corresponding attention gate AGⱼ is computed by virtue of the following equations:

$$[ Math 3 ]$$

$${q}_{att}^{l} = {ψ}^{T} ( {σ}_{1} ( ( {\sum }_{j = 1}^{4} {W}_{x}^{T} {x}_{i , j}^{l} + {b}_{{x}_{i , j}} ) + {W}_{g}^{T} {g}_{i , j} + {b}_{{g}_{i , j}} ) ) + {b}_{ψ}$$

$$[ Math 4 ]$$

$${α}_{i , j}^{l} = {σ}_{2} ( {q}_{att}^{l} ( {x}_{i , j}^{l} , {g}_{i , j} ; {Θ}_{a t t} ) )$$

where

$${q}_{att}^{l}$$

is the attention quotient used to determine the attention coefficients αⱼ, σ₁ and σ₂ are rectified linear unit, a.k.a ReLU, and sigmoid activation functions, respectively,

$${W}_{x}^{T} , {W}_{g}^{T}$$

and ψ^{T} are linear transformations that are intended to reduce the consumption of parameters and of computing resources, and that combine with the bias terms b_{ψ}, bₓ_{_{i,j}}, and b_{g}_{_{i,j}} to form a set of parameters Θₐₜₜ.

The attention module makes it possible to highlight regions important to extraction of features during execution of the convolution layers, and to remove irrelevant regions from the image.

Preferably, the operation of addition of the encoded data is performed on all the input data with each attention signal gⱼ, mainly in order to increase aligned weights and decrease unaligned weights, this reducing spatial information and highlighting important features.

The features extracted from the input are advantageously selected by virtue of the information contained in the attention signals gⱼ.

The input features x₁, . . . , x_{J} are advantageously scaled with respect to the attention coefficients αⱼ, in order to identify meaningful areas of the image, after having passed through a trilinear interpolation

$${W}_{x}^{T} , {W}_{g}^{T}$$

### and ψ^{T}.

In one preferred embodiment, the transformation W produces a weight matrix that is given to the sigmoid activation function in order to limit the values of the attention coefficients (α_{i,1}, α_{i,2}, α_{i,3}, α_{i,4})ϵ[0, 1].

A resampler may be used to extend the dimensions of the weight matrix.

At the output of each attention gate, a concatenation operation may be performed between the attention signal gⱼ and the output data \hat{x}, given that they are of different dimensions.

Elementwise multiplication between the input features and the attention coefficients advantageously leads to the output data (\hat{x}_{i,1}, \hat{x}_{i,2}, \hat{x}_{i, 3}, \hat{x}_{i,4}).

### Preliminary Measurements

In one preferred embodiment, the EIT measurement of the body comprising a cylindrical part containing a fluid, in order to obtain the data on electrical values of the body measured beforehand, comprises the following steps:
i. arranging a number nₑ of electrodes around a periphery of the cylindrical part of the body,
ii. simultaneously exciting each of the nₑ electrodes, each electrode being excited by a potential Vₙ^{exc} having the form:

$$[ Math 5 ]$$

$${V}_{n}^{exc} ( t ) = A {\sum }_{m = 1}^{{n}_{e}} cos ( 2 π {f}_{m} t ) [ {δ}_{m}^{𝕆} cos ( m {θ}_{n} ) + {δ}_{m}^{𝔼} sin ( \frac{m {θ}_{n}}{2} ) ]$$

where A is a signal amplitude, θₙ is the angular position of the electrode Eₙ, fₘ=m*f₀ is an oscillation frequency, and f₀ is a fundamental frequency chosen such that fₘ is lower than the Nyquist frequency of the system for any m,
iii. measuring the electrical properties of the body using the nₑ electrodes,
iv. processing the data generated in measuring step iii, this comprising the following sub-steps:
a) for each electrode Eₙ, computing data points Mₙ defined by:

$$[ Math 7 ]$$

$${M}_{n} ( k ) = \frac{1}{R P} \vert {\sum }_{p = 0}^{P - 1} {V}_{n}^{meas} ( p ) {e}^{i k {β}_{p}} \vert$$

where R is the resistance of the resistor used to measure Vₙ^{meas} with Vₙ^{meas}=R Iₙ across the terminals of the resistor, P is the number of points in a discrete sequence of measurements of the current Iₙ, p is the discrete time, k is a Fourier coefficient between 1 and (nₑ−1) and βₚ=(2πp/P).

### Use of the Method

The invention also relates to use of the method that has just been described to reconstruct the distribution of the electrical properties of a pipe of a nuclear facility, a two-phase flow in particular passing through the pipe.

### Computer Program Product

The invention also relates, according to another of its aspects, to a computer program product comprising a medium and, recorded on this medium, processor-readable instructions that, when executed, allow the reconstructing method according to the invention to be performed.

### Device

The invention lastly relates to a device for implementing the method according to the invention, comprising:
an acquiring system comprising at least one programmable logic array, a module for generating analogue signals and a module for measuring analogue signals, a plurality of electrodes in particular being connected to the acquiring system,
a computer configured to control the acquiring system,
a neural network integrated into or connected to the computer, the neural network comprising:
   an autoencoder comprising a plurality of levels L₁, . . . , L_{J} each comprising at least one convolution layer and at least one dropout layer, and
   an attention module comprising attention gates AG₁, . . . , AG_{J-1}, each having an associated attention signal gⱼ.

The features described above in respect of the method are applicable to the use, the computer program product and the device, and vice versa.

### BRIEF DESCRIPTION OF THE DRAWINGS

FIG. 1 shows a flowchart illustrating one example of steps of implementation of the method according to the invention,

FIG. 2 illustrates one example of an architecture for implementing the method according to the invention,

FIGS. 3A, 3B, 3C, and 3D show in detail an example of attention gates used in the invention,

FIG. 4 illustrates comparative results between the method according to the invention and the prior art, and

FIG. 5 represents a graph illustrating the mean squared error obtained when using the method according to the invention.

### DETAILED DESCRIPTION

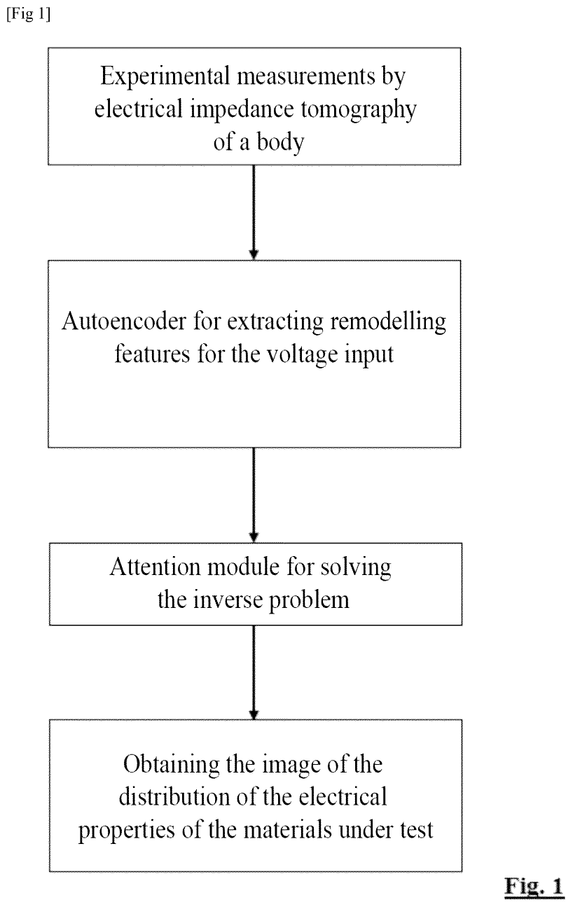

FIG. 1 illustrates a flowchart showing the steps of one example of implementation of the method according to the invention.

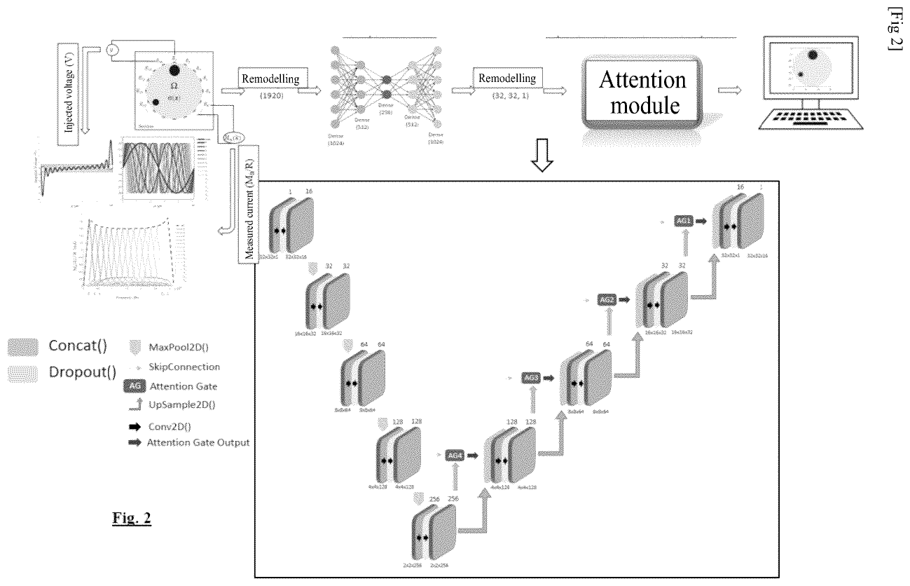

In a first step, experimental measurements by electrical impedance tomography are carried out on a body comprising a cylindrical part inside of which a fluid flows, using electrodes arranged around a periphery of the cylindrical part of the body, each electrode having been excited by a potential of predefined form. The electrodes are placed in a non-intrusive manner on a circular periphery of the body, as may be seen in FIG. 2. In this example, the electrodes are distributed angularly in a regular manner around the periphery of the body.

The electrodes are connected to a printed circuit board, which is connected to a data-acquiring system. A screen makes it possible to view the data and images produced from these data. The data-acquiring system contains a Linux operating system (HOST) that controls an FPGA, also contained in the data-acquiring system.

The acquiring system makes it possible to generate the analogue excitation signals and to measure the analogue measurement signals delivered by the electrodes.

Data on electrical values Mₙ(k) are thus obtained.

In a second step, these data are processed by the autoencoder of the neural network according to the invention in order to remodel them to obtain encoded data x₁, . . . , x_{J} for each layer level L₁, . . . , L_{J} of the autoencoder, as shown in FIG. 2. Each level comprises at least one convolution layer and at least one dropout layer. The data are processed by the layers and concatenated.

As may be seen in FIG. 2, max-pooling from one layer level L₁, . . . , L_{J} to another is used to compress the data on electrical values.

In a third step, the attention module according to the invention is used to solve the inverse problem. This attention module comprises attention gates AG₁, . . . , AG_{J-1}, each having an associated attention signal gⱼ.

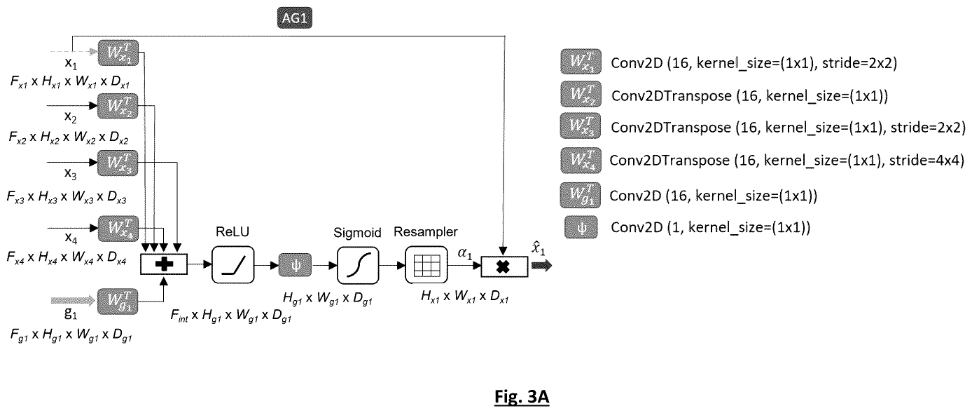

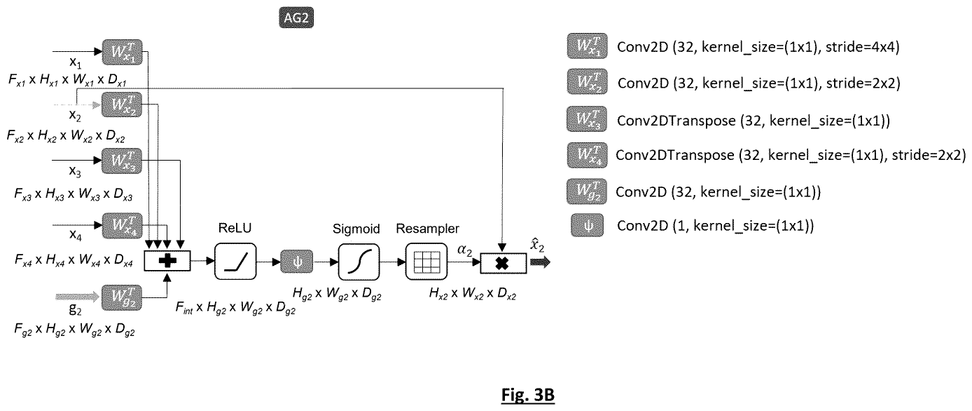

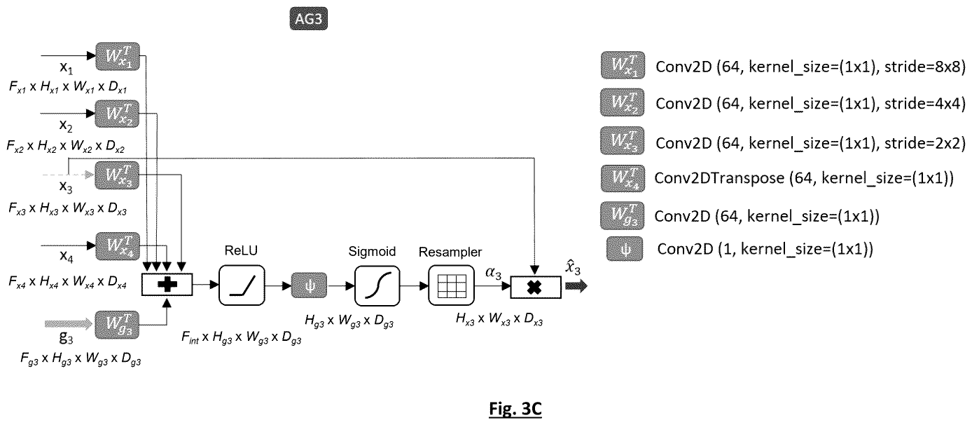

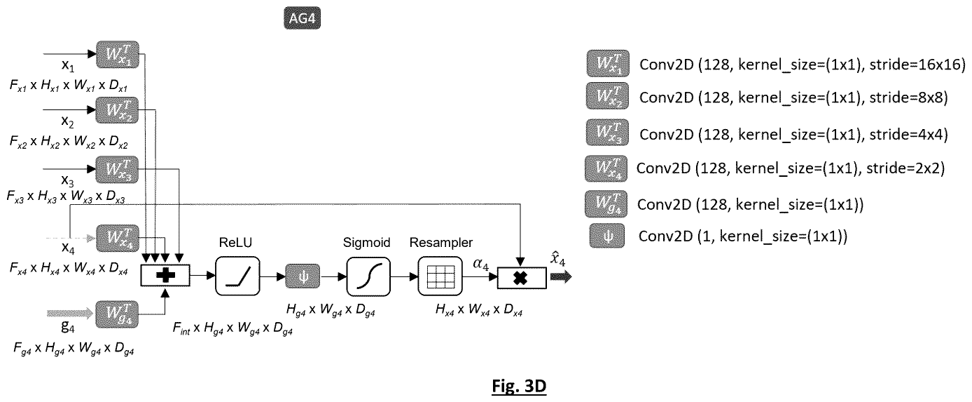

As shown in FIGS. 3A, 3B, 3C, and 3D in order to compute the coefficient αⱼ of an attention gate AGⱼ, the latter is configured to add the encoded data x₁, . . . , x_{J} to the attention signal gⱼ of the corresponding attention gate AGⱼ, depending at least on the concatenation of the output data \hat{x}ⱼ₊₁ of the attention gate of higher rank AGⱼ₊₁ and on decoded data originating from the level of higher rank Lⱼ₊₂ than that of the attention gate of higher rank AGⱼ₊₁. The result of this addition is transformed by at least one mathematical function so as to obtain the coefficient αⱼ.

Preferably, and in the example in question, the coefficient αⱼ of the corresponding attention gate AGⱼ is computed by virtue of the following equations:

$$[ Math 3 ]$$

$${q}_{att}^{l} = {ψ}^{T} ( {σ}_{1} ( ( {\sum }_{j = 1}^{4} {W}_{x}^{T} {x}_{i , j}^{l} + {b}_{{x}_{i , j}} ) + {W}_{g}^{T} {g}_{i , j} + {b}_{{g}_{i , j}} ) ) + {b}_{ψ}$$

$$[ Math 4 ]$$

$${α}_{i , j}^{l} = {σ}_{2} ( {q}_{att}^{l} ( {x}_{i , j}^{l} , {g}_{i , j} ; {Θ}_{a t t} ) )$$

where

$${q}_{att}^{l}$$

is the attention quotient used to determine the attention coefficients αⱼ, σ₁ and σ₂ are rectified linear unit, a.k.a ReLU, and sigmoid activation functions, respectively,

$${W}_{x}^{T} , {W}_{g}^{T}$$

and ψ^{T} are linear transformations that are intended to reduce the consumption of parameters and of computing resources, and that combine with the bias terms b_{ψ}, bₓ_{_{i,j}}, and b_{g}_{_{i,j}} to form a set of parameters Θₐₜₜ.

The transformation ψ produces a weight matrix that is given to the sigmoid activation function in order to limit the values of the attention coefficients, a resampler is used to extend the dimensions of the weight matrix.

In the example shown, as may be seen in FIG. 2, skip connections are formed between the layer levels L₁, . . . , L_{J} to deliver the encoded data x₁, . . . , x_{J} to the input of the attention gates.

In the step of computing the attention coefficients, the encoded data x₁, . . . , x_{J} are, depending on their spatial dimension, convoluted or transposed to match the spatial dimension of the attention signal in question, as shown in FIGS. 3A, 3B, 3C, and 3D.

For example, in the attention gate AG₁, the spatial dimension of x₁ is twice that of the attention signal g₁. In order to be able to add them, it is therefore necessary to divide the dimension of x₁ by 2 (Conv2D with stride=2). As regards the other signals xⱼ received as input, their spatial dimension is less than that of the attention signal g₁, except for x₂ which is at the same dimensional level. It is thus necessary to perform an inverse convolution with different strides (stride=1 for x₂, 2 for x₃ and 4 for x₄) in order to add the signals with g₁.

The same principle applies with AG₂, AG₃, AG₄.

In this figure, F, H, W, D and Fᵢₙₜ, are features, height, width, input channel or depth in the case of 3D data, and intermediate features, respectively.

The output data x_{J} of a layer level Lⱼ of the autoencoder are multiplied by the coefficient αⱼ of the corresponding attention gate AGⱼ, thus computed, in order to obtain output data \hat{x}ⱼ of the j-th attention gate AGⱼ, as illustrated in FIGS. 3A, 3B, 3C, and 3D. This step is repeated until a first attention gate AG₁ is reached, in order to obtain the output data \hat{x}₁ of the first attention gate AG₁.

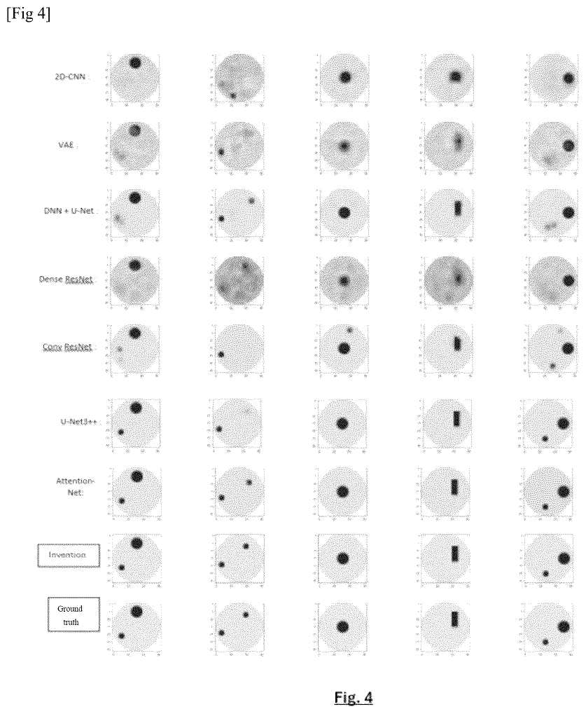

As shown in FIG. 2, the output data \hat{x}₁ of the first attention gate (AG₁) are concatenated with the decoded data delivered by the second level (L₂) in order to obtain, in the last step of FIG. 1, a data matrix representative of an image of the distribution of the electrical properties of at least one material of the body. In this example, the image is a 32×32 matrix. FIG. 4 shows some of the results obtained by virtue of implementation of the method according to the invention and compared with other known architectures: 2D-CNN, Variational-Auto-Encoder (VAE), Generative DNN with U-Net, Dense ResNet, Cony ResNet, U-Net3++, Attention-Net.

The images from left to right in FIG. 4 correspond to tests performed on a body having a cylindrical part that may contain:
two rods of circular cross section (of 1 cm and 2 cm diameter),
two rods of circular cross section (of 1 cm diameter),
one rod of circular cross section (of 2 cm diameter),
one rod of rectangular cross section (2.5×1 cm in area), and
two rods of circular cross section (of 1 cm and 2 cm diameter).

It will be noted that, for the sake of brevity, only the results of certain tests have been illustrated but that the conclusions are the same for all tests carried out.

It may be seen that, before U-Net3++, the known architectures were not optimised enough to reconstruct conductivity, mainly due to the vanishing gradient problem, since there were no skipped connections. The exception is the DNN+U-Net architecture in which U-Net includes these skipped connections but feature extraction is initiated with a deep neural network, which is not optimised for image data compared to a convolutional neural network. For U-Net3++, looking at the second image from left to right, the network failed to identify spatial features required for accurate reconstruction, something that was improved with the conventional Attention-Net network; however, this neural network had problems with the conductivity of the background water and may be seen in image N°5 of FIG. 4. The network used in the invention shows very good reconstruction results with a better identification of the spatial edges.

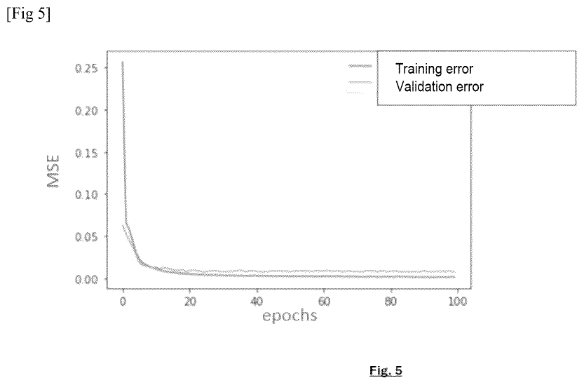

Table 1 shows that the measurements give better results with the invention. Even though R² has a high value in the proposed architecture, it may lead to misinterpretations. The RMSE and SER values are quite low, which is a sign of a good regression, and are located in the range of the MSE loss function, as shown in FIG. 5.

TABLE 1

| | Metrics | | |
|---|---|---|---|
| | R² | RMSE | SER |
| Architectures | (%) | (μS/cm) | (μS/cm) |
| 2D-CNN | 68.3 | 0.3001 | 0.3240 |
| VAE | 70.9 | 0.2769 | 0.2831 |
| DNN + U-Net | 76.3 | 0.2547 | 0.2342 |
| Dense ResNet | 80.4 | 0.2010 | 0.1912 |
| Conv ResNet | 85.9 | 0.1832 | 0.1447 |
| U-Net3++ | 91.7 | 0.1521 | 0.1272 |
| Attention-Net | 92.3 | 0.1308 | 0.1187 |
| AIA-Net | 98.5 | 0.1012 | 0.1009 |

FIG. 5 shows that the mean-squared-error loss function is very low, this indicating a good match between the voltage input data and the conductivity output data. The validation loss exhibits small variations, this indicating that the model of the implemented neural network is stable. In addition, the fact that the values of the two losses are close indicates an absence of over-fitting or under-fitting.

The invention is not limited to the examples that have just been described; it is in particular possible to combine features of the illustrated examples with one another in variants that have not been illustrated.

Other variants and improvements may be envisioned without however departing from the scope of the invention. In particular, the method according to the invention may be implemented by means of a neural network different from the one described, in particular one comprising additional layers.

The invention may be used in the nuclear field, in particular as a method of prevention, when bubbles appear in the primary circuit, and of cavitation in the pumps of various circuits. The invention may be applied to the medical field, in particular in supervision of the lungs and detection of anomalies, in particular when simultaneous excitation is employed.

The method according to the invention may be used in the food-processing field, in particular to count fruit and vegetables, in the petroleum field, in particular to detect fouling of production wells, or even in the pharmaceutical field, for example to detect foreign bodies during the manufacture of medicines.

### LIST OF CITED REFERENCES

[1]R. Guardo & al., “A Neural Network Approach To Image Reconstruction In Electrical Impedance Tomography”, IEEE, 1991
[2]A. Nejatali & al., “An iterative algorithm for electrical impedance imaging using neural networks”, IEEE, 1998
[3]J. Lampinen & al., “Application of Bayesian neural network in electrical impedance tomography”, IEEE, 1999
[4] Chao Wang & al., “RBF neural network image reconstruction for electrical impedance tomography”, IEEE, 2004
[5] Xiuyan Li & al., “An image reconstruction framework based on deep neural network for electrical impedance tomography”, IEEE, 2017
[6] Jin K. S. & al., “A Learning-Based Method for Solving Ill-Posed Nonlinear Inverse Problems: A Simulation Study of Lung EIT”, SIAM J. Imaging sciences, 2019
[7] Xiaoyan C. & al., “Deep Autoencoder Imaging Method for Electrical Impedance Tomography”, IEEE, 2021
[8] Akarsh P. & al., “Improved Training of Physics-Informed Neural Networks Using Energy-Based Priors: a Study on Electrical Impedance Tomography”, ICLR, 2023
[9] Hao Y. & al., “High-resolution conductivity reconstruction by electrical impedance tomography using structure-aware hybrid-fusion learning”, Sciencedirect, 2024
[10] Ozan Oktay & al., “Attention U-Net: Learning Where to look for the Pancreas”, 1^{st} Conference on MIDL, 2018

1. A method for reconstructing the distribution of the electrical properties of a body comprising a cylindrical part within which a fluid flows, using a neural network and data on electrical values of the body measured beforehand by electrical impedance tomography using electrodes arranged around a periphery of the cylindrical part of the body, each electrode having been excited by a potential of predefined form,
the neural network comprising:
an autoencoder comprising a plurality of levels (L₁, . . . , L_{J}) each comprising at least one convolution layer and at least one dropout layer, and
an attention module comprising attention gates (AG₁, . . . , AG_{J-1}), each having an associated attention signal (gⱼ),
the method comprising the following steps:
i) the data on electrical values are processed successively by each level (L₁, . . . , L_{J}) of convolution layers and of dropout layers of the autoencoder of the neural network so as to encode the data to obtain encoded data (x₁, . . . , x_{J}) for each layer level (L₁, . . . , L_{J}),
ii) in order to compute the coefficient (αⱼ) of an attention gate (AGⱼ), the latter is configured to add the encoded data (x₁, . . . , x_{J}) to the attention signal (gⱼ) of the corresponding attention gate (AGⱼ), depending at least on the concatenation of the output data (\hat{x}ⱼ₊₁) of the attention gate of higher rank (AGⱼ₊₁) and on decoded data originating from the level of higher rank (Lⱼ₊₂) than that of the attention gate of higher rank (AGⱼ₊₁), the result of this addition being transformed by at least one mathematical function so as to obtain the coefficient (αⱼ),
iii) the output data (x_{J}) of a layer level (Lⱼ) of the autoencoder are multiplied by the coefficient (αⱼ) of the corresponding attention gate (AGⱼ) to obtain output data (\hat{x}ⱼ) of the j-th attention gate (AGⱼ),
iv) the previous step is repeated until a first attention gate (AG₁) is reached, in order to obtain the output data (\hat{x}₁) of the first attention gate (AG₁),
v) said output data (\hat{x}₁) of the first attention gate (AG₁) are concatenated with the decoded data delivered by the second level (L₂) in order to obtain a data matrix representative of an image of the distribution of the electrical properties of at least one material of the body.

2. The method according to claim 1, wherein max-pooling from one layer level (L₁, . . . , L_{J}) to another is used to compress the data on electrical values.

3. The method according to claim 1, wherein skip connections are formed between the layer levels (L₁, . . . , L_{J}) to deliver the encoded data (x₁, . . . , x_{J}) to the input of the attention gates.

4. The method according to claim 1, wherein, in step ii), the encoded data (x₁, . . . , x_{J}) are, depending on their spatial dimension, convoluted or transposed to match the spatial dimension of the attention signal in question.

5. The method according to claim 1, wherein the coefficient (αⱼ) of the corresponding attention gate (AGⱼ) is computed by virtue of the following equations:
$$[ Math 3 ]$$
$${q}_{att}^{l} = {ψ}^{T} ( {σ}_{1} ( ( {\sum }_{j = 1}^{4} {W}_{x}^{T} {x}_{i , j}^{l} + {b}_{{x}_{i , j}} ) + {W}_{g}^{T} {g}_{i , j} + {b}_{{g}_{i , j}} ) ) + {b}_{ψ}$$
$$[ Math 4 ]$$
$${α}_{i , j}^{l} = {σ}_{2} ( {q}_{att}^{l} ( {x}_{i , j}^{l} , {g}_{i , j} ; {Θ}_{a t t} ) )$$
where
$${q}_{att}^{l}$$
is the attention quotient used to determine the attention coefficients αⱼ, σ₁ and σ₂ are rectified linear unit, a.k.a ReLU, and sigmoid activation functions, respectively,
$${W}_{x}^{T} , {W}_{g}^{T}$$
and ψ^{T} are linear transformations that are intended to reduce the consumption of parameters and of computing resources, and that combine with the bias terms b_{ψ}, bₓ_{_{i,j}}, and b_{g}_{_{i,j}} to form a set of parameters Θₐₜₜ.

6. The method according to claim 1, wherein, the transformation (ψ) producing a weight matrix that is given to the sigmoid activation function in order to limit the values of the attention coefficients, a resampler is used to extend the dimensions of the weight matrix.

7. Use of the method according to claim 1 to reconstruct the distribution of the electrical properties of a pipe of a nuclear facility, a two-phase flow in particular passing through the pipe.

8. A computer program product comprising a medium and, recorded on this medium, processor-readable instructions that, when executed, allow the reconstructing method according to claim 1 to be performed.

9. A device for implementing the method according to claim 1, comprising:
an acquiring system comprising at least one programmable logic array, a module for generating analogue signals and a module for measuring analogue signals, a plurality of electrodes in particular being connected to the acquiring system,
a computer configured to control the acquiring system,
a neural network integrated into or connected to the computer, the neural network comprising:
an autoencoder comprising a plurality of levels (L₁, . . . , L_{J}) each comprising at least one convolution layer and at least one dropout layer, and
an attention module comprising attention gates (AG₁, . . . , AG_{J-1}), each having an associated attention signal (gⱼ).
